(19) United States
(12) Patent Application Publication
(10) Pub. No.: US 2011/0065348 A1
(43) Pub. Date: Mar. 17, 2011

(54) METHOD FOR MANUFACTURING LIGHT-EMITTING ELEMENT

(75) Inventors: Atsushi Miida, Fujisawa-shi (JP); Haruo Tomono, Machida-shi (JP)

(73) Assignee: CANON KABUSHIKI KAISHA, Tokyo (JP)

(21) Appl. No.: 12/876,841

(22) Filed: Sep. 7, 2010

(30) Foreign Application Priority Data
Sep. 11, 2009 (JP) 2009-210708

(51) Int. Cl. H01J 9/00

(52) U.S. Cl. 445/1

(57) ABSTRACT

A method for manufacturing a light-emitting element includes removing a resin layer of a multilayer composite by thermal decomposition. The multilayer composite includes a luminescent layer containing a plurality of luminescent particles, the resin layer disposed on the luminescent layer, and a light reflection layer disposed on the resin layer. The resin layer contains a solid resin and a plurality of resin particles dispersed in the solid resin. A temperature at which the reduction in mass of the resin particles measured by thermogravimetric analysis reaches 70% is lower than a temperature at which the reduction in mass of the solid resin measured by thermogravimetric analysis reaches 70%.

### BACKGROUND OF THE INVENTION

1. Field of the Invention

The present invention relates to a method for manufacturing a light-emitting element including a luminescent layer and a light reflection layer.

2. Description of the Related Art

In a display device using cathode luminescence, a fluorescent layer on a transparent substrate emits light by irradiating the fluorescent layer with electrons. The electrons are accelerated by setting to an anode potential a metal layer disposed on the fluorescent layer at the side opposite to the transparent substrate, thus penetrating the metal layer to irradiate the fluorescent layer. It is effective to use the metal layer as a light reflection layer in efficiently extracting the light emitted from the fluorescent layer to the transparent substrate side.

In order to enhance the reflectivity of the light reflection layer, the fluorescent layer side (reflection plane) of the light reflection layer needs to be flat. A method is known for forming a flat reflection plane. In this method, a light reflection layer is formed on a flat resin layer (planarizing resin layer) formed on a fluorescent layer, and then, the resin layer is removed by firing so that the light reflection layer has a smoother surface having a smaller roughness than the luminescent layer.

Japanese Patent Laid-Open No. 8-315730 discloses a mixture of organic resins having different firing temperatures as the material of a planarizing resin layer.

When the resin layer is fired to be removed, a crack or a pinhole can be formed undesirably in the light reflection layer. Many cracks or pinholes in the light reflection layer lead to a low reflectivity of the light reflection layer, and result in insufficient brightness or nonuniform emission.

### SUMMARY OF THE INVENTION

According to an aspect of the present invention, there is provided a method for manufacturing a light-emitting element including a luminescent layer containing a plurality of luminescent particles and a light reflection layer. The method includes preparing a multilayer composite including the luminescent layer, a resin layer disposed on the luminescent layer, and the light reflection layer disposed on the resin layer, and removing the resin layer with thermal decomposition. The resin layer contains a solid resin and a plurality of resin particles dispersed in the solid resin. The temperature at which the reduction in mass of the resin particles measured by thermogravimetric analysis reaches 70% is lower than the temperature at which the reduction in mass of the solid resin measured by thermogravimetric analysis reaches 70%.

Further features of the present invention will become apparent from the following description of exemplary embodiments with reference to the attached drawings.

### BRIEF DESCRIPTION OF THE DRAWINGS

FIGS. 1A to 1E are schematic representations of a method for manufacturing a light-emitting element according to an embodiment of the present invention.

FIGS. 2A to 2C are schematic representations of a light-emitting element according to an embodiment of the present invention.

### DESCRIPTION OF THE EMBODIMENTS

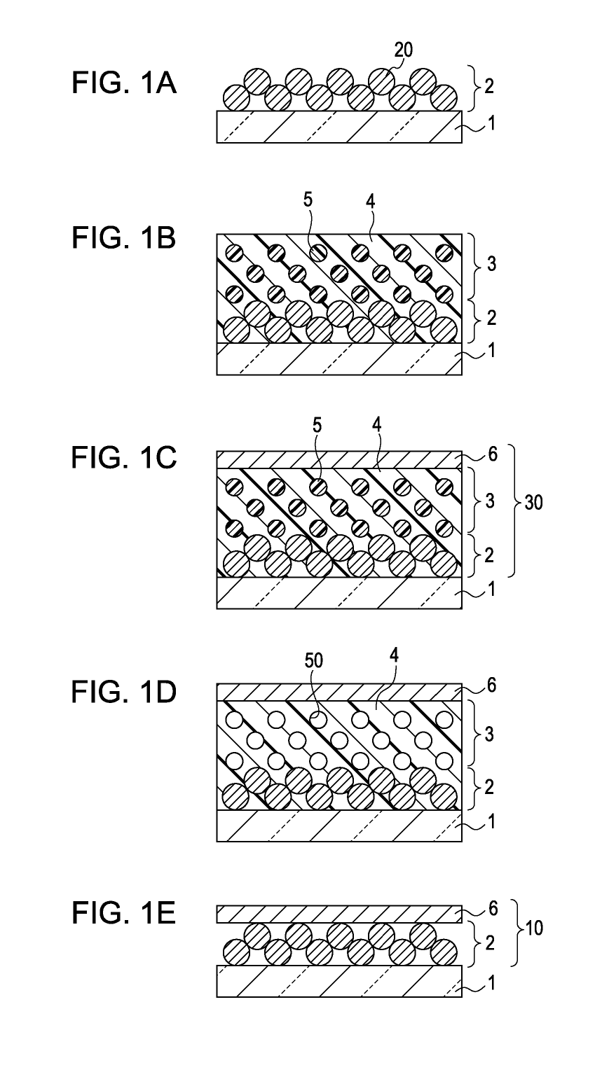

The method for manufacturing a light-emitting element according to an embodiment of the invention will be described in step order with reference to FIGS. 1A to 1E. The light-emitting element 10 of the present embodiment includes a luminescent layer 2 and a light reflection layer 6, as shown in FIG. 1E. The light-emitting element 10 can be used in a state where it is provided on a transparent substrate 1 in such a manner that the luminescent layer 2 is located between the transparent substrate 1 and the light reflection layer 6. The light-emitting element 10 may be formed on a transparent substrate 1.

(Step 1) As shown in FIG. 1A, a transparent substrate 1 having a luminescent layer 2 is prepared.

The transparent substrate 1 can transmit, at least, light having the emission wavelength of the luminescent layer 2, and can transmit visible light having wavelengths of 360 to 830 nm. The substrate also has a sufficiently higher heat resistance than the firing temperature of the resin layer 3 (described later). Typical transparent substrates include glass substrates, such as quartz glass and soda-lime glass.

The luminescent layer 2 is formed on the transparent substrate 1. The luminescent layer 2 contains a plurality of (typically a large number of) luminescent particles 20, and may even mainly contain the luminescent particles 20. A luminescent material constituting each of the luminescent particles 20 may be a phosphor. The phosphor includes at least one of a fluorescent material which causes a fluorescence and a phosphorescent material which causes a phosphorescence. The luminescent layer 2 may further contain another material for binding the luminescent particles 20 to each other or fixing the luminescent particles 20 to the transparent substrate 1.

The luminescent layer 2 has asperities at the surface thereof according to the shape and arrangement of the luminescent particles 20. The degree of the asperities (surface roughness) depends considerably on the size of the luminescent particles 20. In many cases, the size of the luminescent particles 20 has a variation, and the degree of the asperities has a strong correlation to the median diameter of the luminescent particles 20.

The “median diameter” mentioned herein refers to a statistical value and is defined by a particle size D in a particle size distribution when the number of particles having particle sizes of D or more accounts for 50% of the total number of the particles. The above particle size distribution refers to a number particle size distribution in terms of equivalent sphere diameter, and can be measured by dynamic light scattering or laser diffraction scattering. For further information on the particle size, refer to JIS Z8901-2006. The “surface roughness” can be evaluated using the arithmetic mean surface roughness defined by JIS B0601-2001.

If the median diameter of the luminescent particles 20 is extremely reduced, the asperities of the luminescent layer 2 are reduced, and the effect of the present invention becomes small accordingly. If an ordinary fluorescent material having a median diameter of less than 2 μm is used as the luminescent particles 20, the brightness of the luminescent layer 2 may be significantly reduced. In contrast, if the median diameter of the luminescent particles 20 is extremely increased, the asperities of the luminescent layer 2 are increased, and a sufficiently flat light reflection layer 6 cannot be provided accordingly. If the median diameter of the luminescent particles 20 is increased to more than 10 μm, it becomes difficult to provide a high definition light-emitting element or to emit uniformly light. In the present embodiment, luminescent particles 20 having a median diameter in the range of 2 to 10 μm can be advantageously used.

The luminescent layer 2 may be formed by applying a paste containing a large number of luminescent particles onto the transparent substrate 1, followed by firing. The application of the paste may be performed by, for example, a printing method, such as screen printing or offset printing, or dipping, spraying, or spin coating. By firing the applied paste, the organic solvent in the paste is removed, so that the luminescent particles 20 form a luminescent layer. The resulting luminescent layer 2 has logically a thickness not less than the median diameter of the luminescent particles 20. The upper limit of the thickness of the luminescent layer 2 is not particularly limited, but is practically 25 μm or less and may be 15 μm or less. It can be considered that the median diameter of the luminescent particles in the paste does not vary even after the paste has been applied and fired, and is the same as that of the luminescent particles 20 in the luminescent layer 2.

(Step 2) Turning to FIG. 1B, a resin layer 3 is formed on the luminescent layer 2.

The resin layer 3 contains a solid resin 4 and a plurality of (typically a large number of) resin particles 5. The resin particles 5 are dispersed in the solid resin 4. Hence, the solid resin 4 and the resin particles 5 are phase-separated from each other, and the solid resin 4 is a continuous phase. In other words, the resin layer 3 is a disperse system containing the solid resin 4 acting as a disperse medium and the resin particles 5 acting as a dispersoid. Also, the resin layer 3 may be called a composite containing the solid resin 4 acting as a matrix (base material) and the resin particles 5 acting as filler.

The resin layer 3 used herein is different from layers simply containing two or more types of resin particles without a resin continuous phase as a disperse medium. Also, the resin layer 3 used herein is different from a multilayer composite including a layer composed of resin particles and a layer of a continuous solid resin.

The resin layer 3 is formed so as to have a flat surface, that is, so as to have a surface roughness smaller than the surface roughness of the luminescent layer 2. Since, in the present embodiment, the solid resin 4 is in a continuous phase, the resin layer 3 can have a flat surface without asperities formed depending on the shape or arrangement of the resin particles, unlike the luminescent layer 2.

Although the median diameter of the resin particles 5 may be larger than that of the luminescent particles 20, it typically may not be more than the median diameter of the luminescent particles 20. If the luminescent layer 2 contains luminescent particles 20 having a median diameter in the range of 2 to 10 μm, the median diameter of the resin particles 5 may be 1/10 or more of the median diameter of the luminescent particles 20.

The thickness of the resin layer 3 may be set according to the material and forming method of the resin layer 3 and the flatness of the intended light reflection layer 6. The thickness of the resin layer 3 is defined as the distance between the center line obtaining the arithmetic mean surface roughness Ra of the luminescent layer 2 and the center line obtaining arithmetic mean surface roughness Ra of the resin layer 3.

The resin layer 3 is formed to a larger thickness than the median diameter of the resin particles 5. For forming still flatter resin layer 3, the thickness of the resin layer 3 may be ½ or more of the median diameter of the luminescent particles 20, and may be not less than the median diameter of the luminescent particles 20. By forming the resin layer 3 to a thickness of not less than the median diameter of the luminescent particles 20, the surface roughness of the resin layer 3 can be appropriately reduced to less than the surface roughness of the luminescent layer 2.

However, if the resin layer 3 is formed to an excessively large thickness, the light reflection layer 6 may peel after the resin layer 3 has been removed by firing. Accordingly, the resin layer 3 is formed to such a thickness as the light reflection layer 6 does not peel off after removing the resin layer 3 by firing. In practice, the thickness of the resin layer 3 may be 30 μm or less, and may even be 20 μm or less.

Accordingly, the resin particles 5 have a median diameter of 30 μm or less from the viewpoint of practical use even if the resin particles 5 have a larger median diameter than the luminescent particles.

If the luminescent layer 2 containing luminescent particles 20 having a median diameter in the range of 2 to 10 μm is used and the resin particles 5 have a median diameter of not less than 1/10 of the median diameter of the luminescent particles 20 and not more than the median diameter of the luminescent particles 20, the density of the resin particles 5 in the resin layer 3 can be in the range of 5% to 30% by volume.

The temperature at which the reduction in mass of the resin particles 5 measured by thermogravimetric analysis reaches 70% is lower than the temperature at which the reduction in mass of the solid resin 4 measured by thermogravimetric analysis reaches 70% (thermal decomposition will be described later). The temperature at which the reduction in mass measured by thermogravimetric analysis reaches 70% is hereinafter referred to as “standard temperature”.

More specifically, the “standard temperature” refers to the temperature at which the reduction in mass of a substance reaches 70% when a predetermined mass of substance is heated at a rate of 10±1° C./min in air. In other words, it is the temperature at which the mass of a remaining substance comes to 30% of the initial mass of the substance. In heating a substance, the temperature at which the mass of the substance starts decreasing is referred to as thermal decomposition start temperature; the temperature at which the reduction in mass reaches 50% is referred to as thermal decomposition mid-temperature; and the temperature at which the reduction in mass stops is referred to as thermal decomposition termination temperature. The standard temperature and mid-temperature of the resin particles and the solid resin are obtained by respective thermogravimetric analysis. The thermal decomposition start temperature and end temperature are obtained from mass reduction curves prepared by thermogravimetric analysis. For further information on thermogravimetric analysis, refer to JIS K7120-1987.

(Step 3) Turning to in FIG. 1C, a light reflection layer 6 is formed on the resin layer 3.

The light reflection layer 6 is formed of a material having a metallic luster, such as a metallic material. The metallic material used herein may be a metallic element or a mixture such as an alloy. For example, aluminum can be used as the metallic material. The light reflection layer 6 can be formed by known methods, such as vapor deposition and sputtering. The light reflection layer 6 has a thickness that may be in the range of 10 nm to 1 μm, and may even be in the range of 50 nm to 400 nm.

A multilayer composite 30 used as a member of the light-emitting element is thus formed through the above-described Steps 1 to 3. The thus prepared multilayer composite 30 is used in the subsequent Step 4.

(Step 4) Turning to FIG. 1E, the resin layer 3 of the multilayer composite 30 is fired to be removed. Thus the manufacture of the light-emitting element 10 is completed.

In Step 4, the resin layer 3 is removed by heating the resin layer 3 to decompose thermally the solid resin 4 and the resin particles 5. It is ideal to remove completely the resin layer 3, but a residue of the resin layer 3 may be produced. Step 4 can remove part of resin layer components (typically part of solid resin components) trapped between the luminescent particles 20 of the luminescent layer 2 in Step 2 as shown in FIG. 1B. In Step 4, more specifically, the resin layer 3 is heated to a temperature (first temperature) of not less than the standard temperature of the resin particles 5 and less than the standard temperature of the solid resin 4, and then further heated to a temperature (second temperature) of not less than the thermal decomposition termination temperature of the solid resin 4 and not less than the thermal decomposition termination temperature of the resin particles 5. By heating the resin layer 3 to the second temperature, the resin layer 3 is removed. For example, the resin layer 3 may be heated to the second temperature at a constant heating rate. Alternatively, after the resin layer 3 is heated to the first temperature and kept at the first temperature for a predetermined time, the resin layer 3 may be heated to the second temperature and kept at the second temperature for a predetermined time. The heating rates and predetermined keeping times of the solid resin 4 and the resin particles 5 can be appropriately set according to the materials, their combination, and their mass.

The second temperature is set to be lower than temperatures at which the transparent substrate 1, the luminescent layer 2 or the light reflection layer 6 is deformed or degraded to impair the function of the light-emitting element. More specifically, the second temperature is set to not more than the glass transition temperature of the transparent substrate 1 and not more than the melting point of the light reflection layer 6. In practice, the second temperature is 600° C. or less.

FIG. 1D schematically shows a state in the course of Step 4, more specifically, a state at a temperature between the first temperature and the second temperature. As described above, the thermal decomposition termination temperature of the resin particles 5 is lower than that of the solid resin 4. Hence, the resin particles 5 are burned to disappear prior to the solid resin 4. Consequently, as shown in FIG. 1D, cavities 50 are formed in the resin layer 3 in portions in which the resin particles 5 have lain. Thus, the resin layer 3 becomes porous. Although FIG. 1D shows the state where the mass of the solid resin 4 is not reduced, it may be reduced depending on the thermal decomposition start temperature of the solid resin 4. In such a case, the shape of the cavities 50 often differs from the external shape of the resin particles 5. The cavity may not be completely vacant. Part of the resin particles 5 may remain without completing thermal decomposition, or a residue of the resin particles 5 may be left.

The surface asperities of the luminescent layer 2 may cause pinholes or cracks in the light reflection layer 6. Many cavities 50 are formed in the resin layer 3 in the course of Step 4. The cavities 50 may alleviate the effect of the surface asperities of the luminescent layer 2 to prevent pinholes or cracks from being formed in the light reflection layer 6. In addition to forming the flat resin layer 3 by use of the solid resin 4, asperities of the resin layer 3 resulting from the cavities 50 can be appropriately reduced by using resin particles 5 having a median diameter of not more than the median diameter of the luminescent particles 20. Accordingly, pinholes resulting from the surface roughness of the resin layer 3 may be appropriately reduced.

In general, the thermal decomposition start temperature and end temperature of a resin have ranges from several tens to several hundreds of degree centigrade. The ranges of thermal decomposition start temperature and the thermal decomposition termination temperature of the solid resin 4 often overlap with those of the resin particles 5. In embodiments of the present invention, the resin particles 5 have a lower standard temperature than the solid resin 4. As long as the reduction in mass of the resin particles 5 reaches 70% so that 30% or more of the solid resin 4 remains, it can be substantially considered that cavities 50 are formed in the resin layer 3, and accordingly, the effect of the asperities of the luminescent layer 2 can be reduced. Although it is generally advantageous that the difference in standard temperature between the resin particles 5 and the solid resin 4 is large, the suitable difference in standard temperature depends on the materials of the solid resin 4 and the resin particles 5, their combination, and the heating method and conditions. In practice, the difference in standard temperature may be 10° C. or more, and may even be 50° C. or more. The resin particles 5 may have a lower thermal decomposition termination temperature than the solid resin 4. If the thermal decomposition termination temperature of the solid resin 4 is higher than that of the resin particles 5, the solid resin 4 allows the resin particles 5 to be held in the resin layer 3, thus preventing the resin particles 5 from coming apart.

The thermal decomposition of the resin layer 3 produces a gas. The gas is released to the external space through the end of the resin layer 3 or gaps between the luminescent particles 20 of the luminescent layer 2. The gas can also be released through a tiny pinhole or crack that may be formed in the light reflection layer 6.

The procedure for forming the resin layer 3 in Step 2, the solid resin 4 and the resin particles 5 will be described in detail.

The resin layer 3 can be formed by solidifying a liquid resin composition applied onto the luminescent layer 2. The resin composition contains a liquid (hereinafter referred to as liquid resin) that can be solidified into the solid resin 4 and a large number of resin particles dispersed in the liquid resin. It may be the case, from the viewpoint of the dispersibility of the resin particles 5 in the resin layer 3, that a resin composition in which the resin particles have been dispersed in the liquid resin in advance is applied onto the luminescent layer 2.

Alternatively, resin particles may be added to the liquid resin previously applied on the luminescent layer 2, followed by dispersing the resin particles in the liquid resin, or the liquid resin may be applied to resin particles previously disposed on the luminescent layer 2, followed by dispersing the resin particles in the liquid resin. A resin film previously prepared by dispersing resin particles 5 in the solid resin 4 may be provided on the luminescent layer 2 and heated to bond firmly each other.

The application of the resin composition may be performed by, for example, a printing method, such as screen printing or offset printing, or dipping or spraying. Before applying the resin composition onto the luminescent layer 2, a surfactant may optionally be applied over the surface of the luminescent layer 2.

If a solution containing the solid resin 4 dissolved in a solvent is used as the liquid resin, the liquid resin can be solidified by drying. If a melted solid resin 4 is used as the liquid resin, the liquid resin can be solidified by cooling. If a liquid containing a precursor of the solid resin 4 is used as the liquid resin, the liquid resin can be solidified by polymerization. The precursor of the solid resin 4 may be a thermosetting material or a photo-curable material. In the liquid containing a precursor of the solid resin 4, the precursor itself may be liquid, or a solution of a solid precursor may be used. The solidification may be performed in combination with curing.

The precursor of the solid resin 4 may be a photo-curable material from the viewpoint of easy patterning. This means that the resin composition may be photosensitive. A photosensitive resin composition allows patterning of a plurality of light-emitting elements 10 at one time by exposing the applied resin composition to light. The thickness of the coating of the resin composition is reduced at the edge due to the flow of liquid resin. Consequently, resin particles 5 become liable to be exposed at the surface of the resin layer 3 to form protrusions at the surface of the light reflection layer 6, or to break the light reflection layer 6. The patterning can reduce protrusions.

Although the resin particles to be dispersed in the liquid resin may be liquid, it may be advantageous that the resin particles are the same as the resin particles 5 in the resin layer 3 and are solid particles. Hence, it may be the case in Step 2 that the resin particles do not differ between the resin composition and the resin layer 3. A liquid being a continuous phase may be used as the liquid resin from the viewpoint of forming the solid resin 4.

In an approach other than the method of solidifying a liquid resin composition to form the resin layer 3, a previously prepared resin film containing resin particles 5 dispersed in a solid resin 4 may be disposed on the luminescent layer 2. In this instance, the resin film may be pressed to adhere to the luminescent layer 2, or may be bonded to the luminescent layer 2 with an adhesive. The resin film may be provided with the light reflection layer 6 thereon in advance before disposing the resin film on the luminescent layer 2.

Examples of the solid resin 4 include acrylic resin, melamine resin, urea resin, acrylic-melamine copolymer, melamine-urea copolymer, polyurethane resin, polyester resin, epoxy resin, alkyd resin, polyamide resin, vinyl resin, cellulose resin, and mixtures of these resins. These resins are specified in JIS K6900-1994.

From the viewpoint of high thermal decomposition properties, the solid resin 4 can be acrylic resin, polyamide resin, polyester resin, or polyurethane resin. Furthermore, from the viewpoint of photo-curable property, acrylic resin can be used. The acrylic resin refers to a polymer of an acrylic acid or an acrylic acid structure derivative, or a copolymer of an acrylic acid or acrylic acid derivative with another monomer, and is a resin (plastic) mainly containing a maximum mass of acrylic monomers.

If an acrylic resin is used as the solid resin 4, the precursor of the solid resin 4 added to the liquid resin may be a polyfunctional acrylic monomer, a monofunctional acrylic monomer, a reactive acrylic polymer, or a mixture of these monomers. An acrylic resin dissolved in a solvent may of course be used as the liquid resin.

Examples of the polyfunctional acrylic monomer include 1,4-butanediol di(meth)acrylate, 1,6-hexanediol di(meth)acrylate, 1,9-nonanediol di(meth)acrylate, glycerol di(meth)acrylate, tripropylene glycol di(meth)acrylate, tetraethylene glycol di(meth)acrylate, trimethylolpropane tri(meth)acrylate, pentaerythritol triacrylate, glycerol triacrylate, pentaerythritol tetraacrylate, ditrimethylolpropane tetraacrylate, and dipentaerythritol hexaacrylate.

The reactive acrylic polymer may be a copolymer of a monofunctional acrylic monomer, such as an acrylic acid or an alkyl acrylate, and a bifunctional acrylic monomer, such as glycerol diacrylate. Examples of such reactive acrylic polymer include acrylic acid-alkyl acrylate-butanediol diacrylate copolymers and acrylic acid-alkyl acrylate-glycerol diacrylate copolymers. Commercially available reactive acrylic polymers include BISCOAT series produced by Osaka Organic Chemical Industry, ARON series produced by Toagosei, and EBECRYL series produced by Daicel-Cytec Company.

If a photo-curable resin is used, it may be the case in view of polymerization by exposure to UV light that the liquid resin contains a photopolymerization initiator. Examples of the photopolymerization initiator include benzophenones, such as benzophenone, Michler's ketone, and 4,4-bis(diethylamino)benzophenone; anthraquinones, such as t-butylanthraquinone and 2-ethylanthraquinone; thioxanthones; benzoin alkyl ethers; and benzyl ketals.

Furthermore, it may be the case that the liquid resin contains a solvent, such as water or an organic solvent, for adjusting the viscosity of the resin composition so as to be suitable for coating. The solvent is selected from those not dissolving the resin particles dispersed in the liquid resin. If an acrylic resin is used as the solid resin 4, examples of the solvent include isopropyl alcohol, toluene, xylene, methyl ethyl ketone, terpineol, butyl Carbitol, and butyl Carbitol acetate.

The resin particles 5 can be prepared by pulverizing a resin block. It may be however, that the resin particles 5 have a uniform shape rather than random shapes, and that the resin particles 5 are substantially spherical particles (hereinafter referred to as resin spheres).

The resin spheres can be prepared by a known method. For example, it may be prepared by suspension polymerization. If a thermoplastic resin is used, the resin spheres may be formed by atomizing the resin melted by heating, followed by cooling.

The material of the resin particles 5 has a lower thermal decomposition termination temperature than that of the solid resin 4. The resins listed above as the solid resin 4 can be used as the material of the resin particles 5. Since alkyl acrylate resins having straight chain structures and olefin resins having straight chain structures generally have low thermal decomposition termination temperatures, they can be used. Such resins include polybutyl methacrylate, polymethyl methacrylate, polyethyl methacrylate, polyethylene, and polystyrene. Resins having a high oxygen content in the molecule also have low thermal decomposition termination temperatures. Such resins include polyacetal and ethyl cellulose.

Commercially available resins may be used. For example, FA series (product name) produced by Fuji Shikiso or BMX series (product name) produce by Sekisui Plastics may be used as the butyl methacrylate-based acrylic resin. Commercially available methyl methacrylate-based acrylic resin spheres include MBX series (product name) produced by Sekisui Plastics, Liosphere (product name) produced by Toyo Ink, and Epostar MA series (product name) produce by Nippon Shokubai. Formaldehyde-condensed resin spheres may be Epostar series (product name) produced by Nippon Shokubai, and polyethylene resin spheres may be LE series (product name) produced by Sumitomo Seika Chemicals.

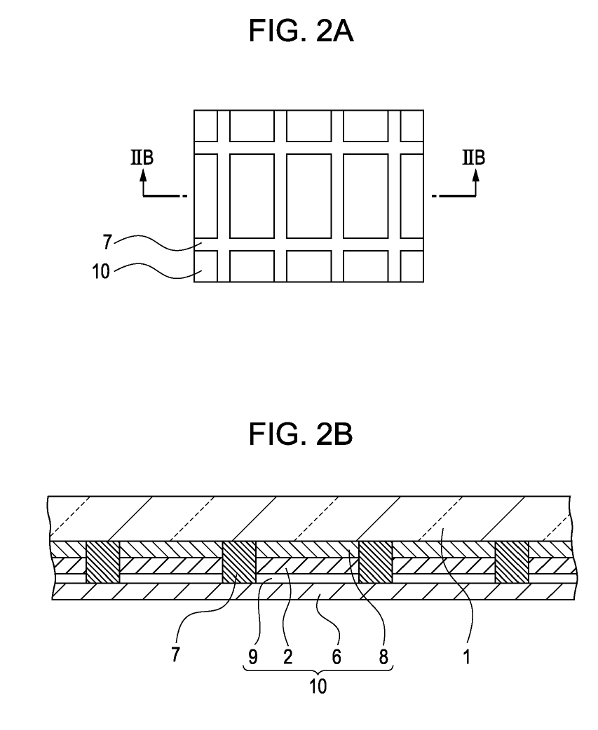

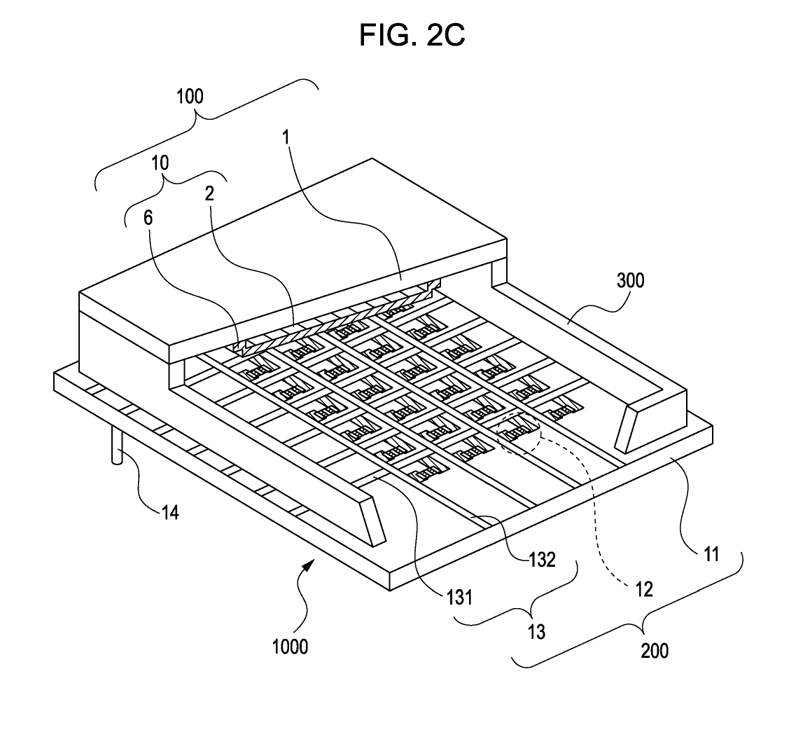

The light-emitting element of an embodiment of the invention will now be described with reference to FIGS. 2A to 2C. FIG. 2A is a plane view of a state where a plurality of light-emitting elements 10 are arranged in a matrix, and FIG. 2B is a sectional view taken dotted chain line IIB-IIB in FIG. 2A.

The light-emitting elements 10 are disposed on a transparent substrate 1. Light emitted from the luminescent layer 2 is transmitted through the transparent substrate 1 and is observed. A light reflection layer 6 over the luminescent layer 2 reflects the light emitted from the luminescent layer 2 to the transparent substrate 1, thereby enhancing the brightness at the transparent substrate side.

In addition, the light-emitting element 10 may include a color filter 8 for enhancing the color purity of light between the luminescent layer 2 and the transparent substrate 1, as shown in FIG. 2B. The light reflection layer 6 may have a multilayer structure. For example, the light reflection layer 6 may include a metal layer and a transparent layer disposed between the metal layer and the luminescent layer. The transparent layer may be made of, for example, magnesium fluoride. By adjusting the thickness of the transparent layer according to the emission wavelength of the luminescent layer 2, the light reflectivity can be controlled.

A light-emitting apparatus including light-emitting elements will now be described. The light-emitting apparatus includes light-emitting elements 10, and a device with which the light-emitting elements 10 emit light. The device with which light is emitted excites the luminescent particles 20 to emit light, and an electron-emitting device may be suitably used. By irradiating the luminescent layer 2 with electrons emitted from the electron-emitting device, the luminescent layer 2 emits light (i.e. a cathode-luminescence). In this instance, the electron energy and the thickness of the light reflection layer 6 are set so that the electrons from the electron-emitting device can penetrate the light reflection layer 6. Since the electron energy depends on the potential of the light reflection layer 6, the light reflection layer 6 can be made of a material having a high electrical conductivity. A hot cathode or a cold cathode may be used as the electron-emitting device. Light emission from the luminescent layer 2 may be made with light (i.e. a photo-luminescence) instead of electrons. For example, an UV light emitting device is used as the device with which the luminescent layer 2 emits light. By irradiating the luminescent layer 2 with UV light through the transparent substrate 1, the luminescent layer 2 can emit light. Also, aspects of the present invention have applicability to a light-emitting apparatus using an electro-luminescence.

The light-emitting apparatus can be used as a display apparatus. The display apparatus includes the light-emitting elements 10, and a device with which the light-emitting elements 10 emit light. As shown in FIG. 2A, a plurality of light-emitting elements 10 are disposed on the transparent substrate 1 in the display apparatus. One or some of the plurality of light-emitting elements 10 emit light to display an image.

A light-shielding layer 7 may be provided between the light-emitting elements 10. The light-shielding layer 7 separates the light-emitting elements 10 from one another to define the respective regions of the light-emitting elements 10. By using a black member as the light-shielding layer 7, the contrast can be enhanced.

As shown in FIG. 2A, the light reflection layer 6 may be held by the light-shielding layer 7, so that a space 9 is formed between the luminescent layer 2 and the light reflection layer 6, without contact between the luminescent layer 2 and the light reflection layer 6. The space 9 increases the effective reflection area of the light reflection layer 6, and accordingly the light reflection layer 6 can efficiently reflect light emitted from the luminescent layer 2.

In the present embodiment, the resin layer 3 can be formed to a large thickness because the light reflection layer 6 does not have many pinholes or cracks even if the thickness of the resin layer 3 is increased. Accordingly, the size of the space 9 (i.e. a distance between the luminescent layer 2 and the light reflection layer 6) can be controlled. The plurality of light-emitting elements may be separated from one another by partitions (ribs) having a height larger than the height from the surface of transparent substrate 1 to the light reflection layer 6 (the height of the light-emitting element 10). The partitions may be used as the light-shielding layer 7.

The light-emitting elements can be used for a panel portion of a cathode-ray tube (CRT), which is a version of display apparatus. In manufacture of a CRT, a panel portion including a plurality of light-emitting elements 10 and a funnel portion provided with an electron gun (electron-emitting device) are prepared. The panel portion and the funnel portion are sealed to form an envelope, and the envelope is evacuated. The step of firing the resin layer 3 to remove it (Step 4) may be performed by heating the envelope after sealing the panel portion provided with the multilayer composite 30 and the funnel portion.

The light-emitting element of an embodiment of the present invention can be applied to a thin display apparatus (display panel). FIG. 2C shows a display panel. The display panel 1000 includes a plurality of light-emitting elements 10 arranged in a matrix and a plurality of electron-emitting devices 12 arranged in a matrix in such a manner that the light-emitting elements 10 oppose the electron-emitting devices 12. The matrixes of the light-emitting elements 10 and the electron emitting devices are surrounded by an envelope including a transparent substrate 1, an insulating substrate 11, and a frame member 300.

In FIG. 2C, a faceplate 100 includes the transparent substrate 1 and the light-emitting elements 10 disposed on the transparent substrate 1. More specifically, the matrix of the light-emitting elements 10 is disposed on the transparent substrate 1, as shown in FIGS. 2A and 2B. A rear plate 200 includes an insulating substrate 11, the matrix of the electron-emitting devices 12 disposed on the insulating substrate 11, and matrix conductor lines 13 connected to the electron-emitting devices 12. The matrix conductor lines 13 include column conductor lines 131 and row conductor lines 132. The column conductor lines 131 and the row conductor lines 132 are isolated from each other by an insulating layer (not shown).

The faceplate 100 and the rear plate 200 are disposed with the looped frame member 300 therebetween in such a manner that the light-emitting elements 10 oppose the electron-emitting devices 12. The faceplate 100 and the rear plate 200 are bonded to the frame member 300. An anode terminal 14 is electrically connected to the metallic light reflection layer 6 through the insulating substrate 11. The space surrounded by the faceplate 100, the rear plate 200 and the frame member 300 is evacuated. The display panel is thus produced. The step of removing the resin layer 3 by firing (Step 4) may be performed by heating the envelope after forming the envelope by combining the transparent substrate 1 provided with the multilayer composite 30 and the rear plate 200.

Electrons are emitted from the electron-emitting devices 12 by applying a driving current to the matrix conductor lines 13. By setting the anode terminal 14 at an anode potential, the emitted electrons are accelerated to penetrate the light reflection layer 6 and irradiate the luminescent layer 2. Thus the light-emitting element 10 can function as an anode. In particular, the light reflection layer 6 acts as the anode. By appropriately selecting the column conductor line 131 and row conductor line 132 to which a driving current is to be applied, a desired electron-emitting device 12 is driven, and the light-emitting element 10 opposing the driven electron-emitting device 12 emits light.

The light-emitting element of an embodiment of the present invention can be suitably applied to an information display apparatus. The information display apparatus includes a plurality of light-emitting elements and a receiving circuit receiving data signals. By emitting light from the light-emitting elements according to data signals, information from the data signals can be displayed. Data signals can be received through a broadcast or communication, or from a recording apparatus or an image pickup apparatus. Data signals include television signals and video signals. Embodiments of the present invention can provide a reliable information display apparatus displaying high quality images.

### EXAMPLES

The method for manufacturing the light emitting element will be described in detail with reference to Examples.

### Example 1

A glass substrate of 300 mm in length by 200 mm in width by 2 mm in thickness was prepared as the transparent substrate 1. A paste containing fluorescent particles as the luminescent particles 20 was applied onto the glass substrate by screen printing. The fluorescent particles had a median diameter of 5 μm and contained a ZnS-based material emitting blue light. The coating of the paste was fired at 450° C., and then, the fluorescent particles were fixed with silica by a sol-gel method. Thus a fluorescent layer having a thickness of 11 μm was formed as the luminescent layer 2. The resulting sample was used as Sample A.

The arithmetic mean surface roughnesses Ra were measured at nine points at the surface of the fluorescent layer: four corners, midpoints between the corners, and the center of the surface of the fluorescent layer, through a laser confocal microscope VK-9700 manufactured by Keyence. The average (hereinafter referred to as surface roughness for convenience's sake) of the nine measurements of arithmetic mean surface roughness Ra was calculated. The surface roughness of the fluorescent layer of Sample A was 4.8 μm.

Subsequently, a resin composition was applied over the entire surface of the fluorescent layer of Sample A by screen printing. The resin composition contained resin particles 5 dispersed in a liquid resin, and was prepared by mixing 10% by weight of resin particles 5, 60% by weight of solid resin precursor, and 30% by weight of organic solvent.

Methyl methacrylate-based acrylic resin spheres were used as the resin particles 5. The precursor of the solid resin 4 was a mixture containing ditrimethylolpropane tetraacrylate as a polyfunctional acrylate, acrylic acid-alkyl acrylate-glycerol diacrylate copolymer as a reactive acrylic polymer, 2-benzyl-2-dimethylamino-1-(4-morpholinophenyl)-butanone-1 as a photopolymerization initiator in a proportion of 6:5:1. The organic solvent was butyl Carbitol acetate.

The coating of the resin composition was prebaked to dry at 100° C. for 10 minutes. The coating was exposed to UV light along a predetermined pattern, and was then post-baked at 170° C. for 40 minutes. Then, the coating was developed with an alkaline developer. A resin layer 3 was thus formed. The section of the resin layer 3 was observed through an electron microscope. It was observed that resin particles 5 were dispersed in the solid resin 4. The thickness of the resin layer 3 was 10 μm. The volume density of the resin particles 5 in the resin layer 3 was estimated from the weight ratio of the solid content (resin component) in the resin composition. The result was 14% by volume.

The thermal decomposition start temperature, the standard temperature, and the thermal decomposition termination temperature of the material of the solid resin 4 formed by solidifying the precursor through the same process as above were obtained by thermogravimetric analysis. The resin particles 5 were subjected to thermogravimetric analysis for the thermal decomposition start temperature, the standard temperature, and the thermal decomposition termination temperature. More specifically, test samples of the solid resin 4 and the resin particles 5 were heated in an air atmosphere from room temperature to 600° C. at a rate of 10° C./min. The reduction in mass by thermal decomposition was measured with a thermogravimetric analyzer, and mass reduction curves were prepared. The thermal decomposition start temperature and the thermal decomposition termination temperature of the solid resin 4 were 250° C. and 470° C., respectively, and the temperature (standard temperature) at which the reduction in mass of the solid resin 4 reached 70% was 390° C. Methyl methacrylate-based acrylic resin spheres had a thermal decomposition start temperature of 250° C., a thermal decomposition termination temperature of 410° C., and a standard temperature of 350° C.

Subsequently, an aluminum layer as the light reflection layer 6 was formed to a thickness of 200 nm on the resin layer 3 by electron beam vapor deposition. A multilayer composite 30 was thus formed.

The multilayer composite was heated on a hot plate in an air atmosphere from room temperature to 500° C. at a rate of 4° C./min. After keeping the multilayer composite at 500° C. for 90 minutes, the temperature was reduced to room temperature at a rate of 4° C./min. The temperature was measured with a thermocouple bonded to the glass substrate. A light-emitting element 10 was thus prepared. The light-emitting element 10 was observed through a cross-section FIB-SEM (focused ion beam scanning electron microscope), and it was found that the resin layer 3 had disappeared.

In the present Example, Samples A1 to A7 were prepared using resin compositions containing resin particles having median diameters of 0.3 to 8 μm, as shown in Table 1. Also, Sample A0 was prepared for comparison, using a resin composition containing 67% by weight of solid resin precursor and 33% by weight of organic solvent without containing resin particles.

The median diameters of the fluorescent particles and the resin particles were measured in advance before preparing the paste or the resin composition. For fluorescent particles and resin particles having median diameters of 6 μm or less, the median diameter was measured by dynamic light scattering with a Zetasizer Nano ZS (product name) manufactured by Sysmex. For particles having a median diameter of more than 6 μm, the median diameters were measured by laser diffraction scattering with Mastersizer 2000 (product name) manufactured by Sysmex. Median diameters of 6 μm or less can also be measured by laser diffraction scattering. It was confirmed that there was not a large difference in external shape observed through an electron microscope between the powder of resin particles and the section of the multilayer composite 30. The apparent sizes of the fluorescent particles and the resin particles observed through an electron microscope were close to the median diameters.

The surface roughness of the resin layer 3 was measured in the same manner as that of the fluorescent layer, and the results of Samples A1 to A7 and Sample A0 were each 0.50 μm or less. The surface roughness of the aluminum layer before removing the resin layer 3 by firing was measured in the same manner as that of the fluorescent layer, and the results of Samples A1 to A7 and Sample A0 were each 0.50 μm or less. It was thus confirmed that the resin layer 3 has a function of planarization.

The surface roughness of the aluminum layer after removing the resin layer 3 by firing was measured in the same manner as that of the fluorescent layer. The result of Sample A0 was 2.5 μm, and the results of Samples A1 to A7 were less than 2.5 μm, particularly 1.2 μm in Sample A6.

The flatness was evaluated with reference to the surface roughness of Sample A6 (100%) whose resin particles 5 have the same median diameter of 5 μm as the median diameter of the fluorescent particles. Samples exhibiting a surface roughness (80% to 120%) similar to Sample A6 were determined to be good. Samples exhibiting results (less than 80%) considerably superior to Sample A6 were determined to be excellent, and samples exhibiting results (more than 120%) considerably inferior to Sample A6 were determined to be fair.

For evaluation for pinholes and cracks, the aluminum layer was observed through an optical microscope at nine points: four corners, midpoints between the four corners, and the center of the aluminum layer. More specifically, the fluorescent layer was irradiated with UV light from the glass substrate side to emit light, and it was taken by photography how much the blue light from the fluorescent layer leaked through the aluminum layer. The transmissive region/non-transmissive region ratio of the taken picture was binarized to obtain a total area of the transmissive regions.

Samples A1 to A7 exhibited superior results to Sample A0, and Sample A6 exhibited a value of half or less of the result of Sample A0.

The degree of pinholes and cracks was evaluated with reference to that of Sample A6 whose resin particles 5 have the same median diameter of 5 μm as the median diameter of the fluorescent particles. Samples exhibiting a degree (50% to 150%) similar to Sample A6 were determined to be good. Samples exhibiting results (less than 50%) considerably superior to Sample A6 were determined to be excellent, and samples exhibiting results (more than 150%) considerably inferior to Sample A6 were determined to be fair.

Evaluation results are shown in the Table 1.

### Example 2

In Example 2, a fluorescent layer containing ZnS-based fluorescent particles emitting blue light having a median diameter of 2 μm was formed to a thickness of 6 μm as the luminescent layer 2. The resulting sample was used as Sample B. The surface roughness of the fluorescent layer of Sample B was 1.8 μm.

Subsequently, a resin layer 3 was formed of a resin composition to a thickness of 5 μm on the fluorescent layer of Sample B. The resin composition was different only in median diameter of the resin particles 5 from the resin composition used in Example 1. Furthermore, a light-emitting element was prepared in the same manner as in Example 1.

In the present Example, samples B8 to B13 were prepared using resin compositions containing resin particles 5 having median diameters of 0.1 to 3 μm, as shown in Table 1. Also, Sample B0 was prepared for comparison, using a resin composition containing 67% by weight of solid resin precursor and 33% by weight of organic solvent without containing resin particles.

The surface roughness of the resin layer 3 was measured in the same manner as that of the fluorescent layer, and the results of Samples B8 to B13 and Sample B0 were each 0.50 μm or less. The surface roughness of the aluminum layer before removing the resin layer 3 by firing was measured in the same manner as that of the fluorescent layer, and the results of Samples B8 to B13 and Sample B0 were each 0.50 μm or less.

The surface roughness of the aluminum layer after removing the resin layer 3 by firing was measured in the same manner as that of the fluorescent layer. The result of Sample B0 was 1.4 μm, and the results of Samples B8 to B13 were less than 1.4 μm, particularly 0.78 μm in Sample B12.

The degree of pinholes and cracks was evaluated. Samples B8 to B13 exhibited superior results to Sample B0, and Sample B12 exhibited a value of half or less of the result of Sample B0.

The flatness and the degree of pinholes and cracks were evaluated in the same manner as in Example 1 with reference to those of Sample B12 whose resin particles 5 have the same median diameter of 2 μm as the median diameter of the fluorescent particles.

Evaluation results are shown in the Table 1.

### Example 3

In Example 3, a fluorescent layer containing ZnS-based fluorescent particles emitting blue light having a median diameter of 10 μm was formed to a thickness of 21 μm as the luminescent layer 2. The resulting sample was used as Sample C. The surface roughness of the fluorescent layer of Sample C was 9.2 μm.

Subsequently, a resin layer 3 was formed of a resin composition to a thickness of 18 μm on the fluorescent layer of Sample C. The resin composition was different only in median diameter of the resin particles 5 from the resin composition used in Example 1. Subsequently, a light-emitting element was prepared in the same manner as in Example 1.

In the present Example, samples C14 to C19 were prepared using resin compositions containing resin particles 5 having median diameters of 0.5 to 12 μm, as shown in Table 1. Also, Sample C0 was prepared for comparison, using a resin composition containing 67% by weight of solid resin precursor and 33% by weight of organic solvent without containing resin particles.

The surface roughness of the resin layer 3 was measured in the same manner as that of the fluorescent layer, and the results of Samples C14 to C19 and Sample C0 were each 1.0 μm or less. The surface roughness of the aluminum layer before removing the resin layer 3 by firing was measured in the same manner as that of the fluorescent layer, and the results of Samples C14 to C19 and Sample C0 were each 1.0 μm or less.

The surface roughness of the aluminum layer after removing the resin layer 3 by firing was measured in the same manner as that of the fluorescent layer. The result of Sample C0 was 3.3 μm, and the results of Samples C14 to C19 were less than 3.3 μm, particularly 2.1 μm in Sample C18.

The degree of pinholes and cracks was evaluated. Samples C14 to C19 exhibited superior results to Sample C0, and Sample C18 exhibited a value of half or less of the result of Sample C0.

The flatness and the degree of pinholes and cracks were evaluated in the same manner as in Example 1 with reference to those of Sample C18 whose resin particles 5 have the same median diameter of 10 μm as the median diameter of the fluorescent particles.

Evaluation results are shown in the Table 1.

### Example 4

In Example 4, a resin layer 3 was formed of a resin composition to a thickness of 10 μm on the fluorescent layer of Sample A. The resin composition was different only in material and median diameter of the resin particles 5 from the resin composition used in Example 1. Subsequently, a light-emitting element was prepared in the same manner as in Example 1.

Butyl methacrylate-based acrylic resin spheres were used as the resin particles 5. Butyl methacrylate-based acrylic resin spheres had a thermal decomposition start temperature of 250° C., a thermal decomposition termination temperature of 400° C., and a standard temperature of 330° C.

In the present Example, samples A20 to A26 were prepared using resin compositions containing resin particles 5 having median diameters of 0.1 to 8 μm, as shown in Table 1.

The surface roughness of the resin layer 3 was measured in the same manner as that of the fluorescent layer, and the results of Samples A20 to A26 were each 0.50 μm or less. The surface roughness of the aluminum layer before removing the resin layer 3 by firing was measured in the same manner as that of the fluorescent layer, and the results of Samples A20 to A26 were each 0.50 μm or less.

The surface roughness of the aluminum layer after removing the resin layer 3 by firing was measured in the same manner as that of the fluorescent layer. The surface roughnesses of Samples A20 to A26 were less than 2.5 μm, and the surface roughness of Sample A25 was 1.0 μm.

The degree of pinholes and cracks was evaluated. Samples A20 to A26 exhibited superior results to Sample A0, and Sample A25 exhibited a value of half or less of the result of Sample A0.

The flatness and the degree of pinholes and cracks were evaluated in the same manner as in Example 1 with reference to those of Sample A25 whose resin particles 5 have the same median diameter of 5 μm as the median diameter of the fluorescent particles.

Evaluation results are shown in the Table 1.

TABLE 1

| | | Median diameter | Resin particles | | Aluminum layer | |
|---|---|---|---|---|---|---|
| | | (μm) of fluores- | Median | Density | Flatness | Pinholes/ |
| | Sample | cent particle | diameter (μm) | (Volume %) | (μm) | Clacks |
| Example 1 | A1 | 5 | 0.2 | 14 | Good | Fair |
| | A2 | 5 | 0.5 | 14 | Good | Good |
| | A3 | 5 | 1 | 14 | Excellent | Excellent |
| | A4 | 5 | 2 | 14 | Excellent | Excellent |
| | A5 | 5 | 3 | 14 | Good | Excellent |
| | A6 | 5 | 5 | 14 | 1.2 | Good |
| | A7 | 5 | 8 | 14 | Good | Fair |
| | A0 | 5 | — | — | 2.5 | Bad |
| Example 2 | B8 | 2 | 0.1 | 14 | Good | Fair |
| | B9 | 2 | 0.2 | 14 | Good | Good |
| | B10 | 2 | 0.5 | 14 | Excellent | Excellent |
| | B11 | 2 | 1 | 14 | Excellent | Excellent |
| | B12 | 2 | 2 | 14 | 0.78 | Good |
| | B13 | 2 | 3 | 14 | Good | Fair |
| | B0 | 2 | — | — | 1.4 | Bad |
| Example 3 | C14 | 10 | 0.5 | 14 | Fair | Fair |
| | C15 | 10 | 1 | 14 | Good | Good |
| | C16 | 10 | 5 | 14 | Excellent | Excellent |
| | C17 | 10 | 8 | 14 | Good | Good |
| | C18 | 10 | 10 | 14 | 2.1 | Good |
| | C19 | 10 | 12 | 14 | Fair | Fair |
| | C0 | 10 | — | — | 3.3 | Bad |
| Example 4 | A20 | 5 | 0.1 | 14 | Good | Fair |
| | A21 | 5 | 0.5 | 14 | Good | Good |
| | A22 | 5 | 1 | 14 | Excellent | Excellent |
| | A23 | 5 | 2 | 14 | Excellent | Excellent |
| | A24 | 5 | 3 | 14 | Excellent | Excellent |
| | A25 | 5 | 5 | 14 | 1.0 | Good |
| | A26 | 5 | 8 | 14 | Good | Fair |

From the results of Examples 1 to 4, it is thought that when the resin particles have a smaller median diameter than the fluorescent particles to some extent, a particularly good result can be obtained. It has been found from observations of Samples A0, B0 and C0 that pinholes or cracks are liable to occur at a position corresponding to a recessed portion at the surface of the luminescent layer 2. This is probably because the adhesion between the luminescent layer 2 and the resin layer 3 around the recessed portion is higher than the other portion (protruding portion). When the resin particles 5 have a smaller median diameter than the luminescent particles 20, the possibility that the resin particles 5 are in the recessed portion of the luminescent layer 2 is increased. By previously removing the resin particles 5 by firing, cavities 50 are formed in the recessed portion. It is thought that the luminescent layer 2 and the resin layer 3 are separated from each other in the vicinity of the recessed portion.

When the fluorescent particles have a median diameter in the range of 2 to 10 μm, it is expected that the same or higher effect can be produced in comparison with the case where fluorescent particles have the same median diameter as the resin particles, if the resin particles have a median diameter of 1/10 or more of the median diameter of the fluorescent particles.

In Examples 1 to 4, the volume density of the resin particles were constant. Accordingly, the reduction of the median diameter of the resin particles means that the number of the resin particles per unit volume is considerably increased. If the number of the resin particles increases, it is expected that the effect of the asperities at the surface of the fluorescent layer is evenly reduced as a whole. Accordingly, even though the resin particles have a median diameter of about 1/10 of the median diameter of the fluorescent particles, probably, a sufficient effect can be produced.

When the fluorescent particles have the same median diameter in comparison between Examples 1 and 4, a larger difference in thermal decomposition termination temperature can produce good result.

### Example 5

In Example 5, for forming a light-emitting element, a resin layer was formed of a resin composition on the fluorescent layer of Sample A. The resin composition was different only in volume density of the resin particles 5 from the resin composition of Sample A25 in Example 4.

In the present Example, samples A27 to A33 were prepared using resin compositions containing resin particles 5 having volume densities of 2% to 41% by volume, as shown in Table 2. More specifically, the mass ratio of the solid resin precursor and the resin particles 5 was adjusted. The amount of organic solvent was adjusted so as to be suitable to apply the resin composition.

The surface roughness of the resin layer 3 was measured in the same manner as that of the fluorescent layer, and the results of Samples A27 to A33 were each 0.50 μm or less. The surface roughness of the aluminum layer before removing the resin layer 3 by firing was measured in the same manner as that of the fluorescent layer, and the results of Samples A27 to A33 were each 0.50 μm or less.

The surface roughness of the aluminum layer after removing the resin layer 3 by firing was measured in the same manner as that of the fluorescent layer. The surface roughnesses of Samples A27 to A33 were less than 2.5 μm, and the surface roughness of Sample A25 was 1.0 μm.

The degree of pinholes and cracks was evaluated. Samples A27 to A33 exhibited superior results to Sample A0. The flatness and the degree of pinholes and cracks were evaluated in the same manner as in Example 1 with reference to those of Sample A23.

Evaluation results are shown in the Table 2.

### Example 6

In Example 6, for forming a light-emitting element, a resin layer was formed of a resin composition on the fluorescent layer of Sample B. The resin composition was different only in volume density of the resin particles 5 from the resin composition of Sample B8 in Example 2.

In the present Example, samples B34 to B38 were prepared using resin compositions containing resin particles 5 having volume densities of 3% to 39% by volume, as shown in Table 2. More specifically, the mass ratio of the precursor of the solid resin and the resin particles 5 was adjusted. The amount of organic solvent was adjusted so as to be suitable to apply the resin composition.

The surface roughness of the resin layer 3 was measured in the same manner as that of the fluorescent layer, and the results of Samples B34 to B38 were each 0.50 μm or less. The surface roughness of the aluminum layer before removing the resin layer 3 by firing was measured in the same manner as that of the fluorescent layer, and the results of Samples B34 to B38 were each 0.50 μm or less.

The surface roughness of the aluminum layer after removing the resin layer 3 by firing was measured in the same manner as that of the fluorescent layer. The results of Samples B34 to B38 were smaller than 1.4 μm.

The degree of pinholes and cracks was evaluated. Samples B34 to B38 exhibited superior results to Sample B0. The flatness and the degree of pinholes and cracks were evaluated in the same manner as in Example 1 with reference to those of Sample B8.

Evaluation results are shown in the Table 2.

### Example 7

In Example 7, for forming a light-emitting element, a resin layer was formed of a resin composition on the fluorescent layer of Sample B. The resin composition was different only in volume density of the resin particles 5 from the resin composition of Sample C18 in Example 2.

In the present Example, samples C39 to C43 were prepared using resin compositions containing resin particles 5 having volume densities of 1% to 35% by volume, as shown in Table 2. More specifically, the mass ratio of the precursor of the solid resin 4 and the resin particles was adjusted. The amount of organic solvent was adjusted so as to be suitable to apply the resin composition.

The surface roughness of the resin layer 3 was measured in the same manner as that of the fluorescent layer, and the results of Samples C39 to C43 were each 1.0 μm or less. The surface roughness of the aluminum layer before removing the resin layer 3 by firing was measured in the same manner as that of the fluorescent layer, and the results of Samples C39 to C43 were each 1.0 μm or less.

The surface roughness of the aluminum layer after removing the resin layer 3 by firing was measured in the same manner as that of the fluorescent layer. The results of Samples C39 to C43 were smaller than 3.3 μm.

The degree of pinholes and cracks was evaluated. Samples C39 to C43 exhibited superior results to Sample C0. The flatness and the degree of pinholes and cracks were evaluated in the same manner as in Example 1 with reference to those of Sample C18.

Evaluation results are shown in the Table 2.

TABLE 2

| | | Median diameter | Resin particles | | Aluminum layer | |
|---|---|---|---|---|---|---|
| | | (μm) of fluores- | Median | Density | Flatness | Pinholes/ |
| | Sample | cent particle | diameter (μm) | (Volume %) | (μm) | Clacks |
| Example 5 | A27 | 5 | 2 | 2 | Fair | Fair |
| | A28 | 5 | 2 | 5 | Good | Good |
| | A29 | 5 | 2 | 14 | Good | Good |
| | A30 | 5 | 2 | 19 | Good | Good |
| | A31 | 5 | 2 | 26 | Good | Good |
| | A32 | 5 | 2 | 30 | Fair | Good |
| | A33 | 5 | 2 | 41 | Fair | Fair |
| Example 6 | B34 | 2 | 0.2 | 3 | Fair | Good |
| | B35 | 2 | 0.2 | 5 | Good | Good |
| | B8 | 2 | 0.2 | 14 | Good | Good |
| | B36 | 2 | 0.2 | 30 | Good | Good |
| | B37 | 2 | 0.2 | 34 | Good | Fair |
| | B38 | 2 | 0.2 | 39 | Fair | Fair |
| Example 7 | C39 | 10 | 10 | 1 | Fair | Fair |
| | C40 | 10 | 10 | 3 | Good | Fair |
| | C41 | 10 | 10 | 5 | Good | Good |
| | C18 | 10 | 10 | 14 | Good | Good |
| | C42 | 10 | 10 | 30 | Good | Good |
| | C43 | 10 | 10 | 35 | Fair | Fair |

The results of Examples 5 to 7 suggest that when the resin particles 5 in the resin layer 3 have a volume density in the range of 5% to 30% with median diameters of the luminescent particles 20 and the resin particles 5 in a practical range, favorable results can be obtained without large variation. If the resin particles 5 in the resin layer 3 are extremely reduced, there is not much difference from the resin layer not containing resin particles 5. However, when the median diameters of the luminescent particles 20 and the resin particles 5 were in the above range, good results were obtained by controlling the amount of the resin particles to 5% or more. If the amount of resin particles 5 is extremely increased, the cavities 50 are likely to occupy an excessively large volume. It is accordingly thought that the resin layer 3 becomes coarsely porous, and that the strength of the solid resin 4 is reduced during thermal decomposition. However, when the median diameters of the luminescent particles 20 and the resin particles 5 were in the above range, good results were obtained by controlling the volume density of the resin particles to 30% or less.

### Example 8

In Example 8, a resin layer 3 was formed of a resin composition to a thickness of 10 μm on the fluorescent layer of Sample A. The resin composition was different only in material and median diameter of the resin particles 5 from the resin composition used in Example 1. Subsequently, a light-emitting element was prepared in the same manner as in Example 1.

Polyformaldehyde resin spheres were used as the resin particles 5. Polyformaldehyde resin spheres had a thermal decomposition start temperature of 300° C., a thermal decomposition termination temperature of 400° C., and a standard temperature of 370° C.

In the present Example, samples A44 to A47 were prepared using resin compositions containing resin particles 5 having median diameters of 0.4 to 10 μm, as shown in Table 3.

The surface roughness of the resin layer 3 was measured in the same manner as that of the fluorescent layer, and the results of Samples A44 to A47 were each 0.50 μm or less. The surface roughness of the aluminum layer before removing the resin layer 3 by firing was measured in the same manner as that of the fluorescent layer, and the results of Samples A44 to A47 were each 0.50 μm or less.

The surface roughness of the aluminum layer after removing the resin layer 3 by firing was measured in the same manner as that of the fluorescent layer. The surface roughnesses of Samples A44 to A47 were less than 2.5 μm, and the surface roughness of Sample A46 was 1.5 μm.

The degree of pinholes and cracks was evaluated. Samples A44 to A47 exhibited superior results to Sample A0, and Sample A46 exhibited a value of half or less of the result of Sample A0.

The flatness and the degree of pinholes and cracks were evaluated in the same manner as in Example 1 with reference to those of Sample A46 whose resin particles 5 have the same median diameter of 5 μm as the median diameter of the fluorescent particles.

Evaluation results are shown in the Table 3.

TABLE 3

| | | Median diameter | Resin particles | | Aluminum layer | |
|---|---|---|---|---|---|---|
| | | (μm) of fluores- | Median | Density | Flatness | Pinholes/ |
| | Sample | cent particle | diameter (μm) | (Volume %) | (μm) | Clacks |
| Example 8 | A44 | 5 | 0.4 | 14 | Fair | Fair |
| | A45 | 5 | 2 | 14 | Good | Good |
| | A46 | 5 | 5 | 14 | 1.5 | Good |
| | A47 | 5 | 10 | 14 | Fair | Fair |

### Example 9

Example 9 was performed in the same manner as Example 1, except that another solid resin 4 was used in the resin layer 3. The resin composition contained 5% by weight of the resin particles used in Sample A3 in Example 1, 30% by weight of polyamide resin (alcohol-soluble nylon F30K produced by Nagase ChemteX) as the solid resin 4, and 65% by weight of butyl alcohol. The polyamide resin had a thermal decomposition start temperature of 350° C., a thermal decomposition termination temperature of 490° C., and a standard temperature of b440° C.

Example 9 also produced a highly flat aluminum film having few pinholes and cracks, as in other Examples.

### Example 10

Example 10 was performed in the same manner as Example 1, except that another solid resin 4 was used in the resin layer 3.

The resin composition contained 6% by weight of resin particles used in Sample A3 of Example 1, 40% by weight of polyester resin (TP-219, produced by Nippon Synthetic Chemical Industry) as the soil resin 4, and 54% by weight of methyl isobutyl ketone as organic solvent. The polyester resin had a thermal decomposition start temperature of 410° C., a thermal decomposition termination temperature of 480° C., and a standard temperature of 460° C.

Example 10 also produced a highly flat aluminum layer having few pinholes and cracks, as in other Examples.

The Examples show that a method according to embodiments of the present invention can provide a light-emitting element including a highly reflective light reflection layer having few cracks or pinholes.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-210708 filed Sep. 11, 2009, which is hereby incorporated by reference herein in its entirety.

What is claimed is:

1. A method for manufacturing a light-emitting element including a luminescent layer and a light reflection layer, the method comprising:
preparing a multilayer composite including a luminescent layer containing a plurality of luminescent particles, a resin layer disposed on the luminescent layer, and a light reflection layer disposed on the resin layer; and
removing the resin layer with thermal decomposition,
wherein the resin layer contains a solid resin and a plurality of resin particles dispersed in the solid resin, and the resin particles are such that a temperature at which a reduction in mass of the resin particles measured by thermogravimetric analysis reaches 70% is lower than a temperature at which a reduction in mass of the solid resin measured by thermogravimetric analysis reaches 70%.

2. The method according to claim 1, wherein a median diameter of the resin particles is lower than or equal to a median diameter of the luminescent particles.

3. The method according to claim 2, wherein the median diameter of the luminescent particles is in a range of 2 to 10 μm, and the median diameter of the resin particles is 1/10 or more of the median diameter of the luminescent particles.

4. The method according to claim 3, wherein a density of the resin particles in the resin layer is in a range of 5% to 30% by volume.

5. The method according to claim 1, wherein preparing the multilayer composite includes applying a resin composition onto the luminescent layer, and then solidifying the resin composition,
wherein the resin composition contains a liquid, which is subjected to change into the solid resin by the solidifying, and the resin particles are dispersed in the liquid.

6. The method according to claim 5, wherein the resin composition has photosensitivity, and the resin composition applied onto the luminescent layer is cured in a predetermined pattern by exposure.

7. The method according to claim 6, wherein the solid resin comprises an acrylic resin.

8. The method according to claim 1, wherein a thickness of the resin layer is not less than a median diameter of the luminescent particles, and not more than 30 μm.

9. A method for manufacturing a light-emitting apparatus including a light-emitting element and a device with which the light-emitting element emits light, the method comprising manufacturing the light-emitting element by the method as set forth in claim 1.
